(19) United States
(12) Patent Application Publication
(10) Pub. No.: US 2007/0201741 A1
(43) Pub. Date: Aug. 30, 2007

(54) System and method for decoding a color image

(76) Inventors: Alan J. Epshteyn, Dix Hills, NY (US); Alan J. Livingston, Lindenhurst, NY (US)

Correspondence Address: FAY KAPLUN & MARCIN, LLP, 15O BROADWAY, SUITE 702, NEW YORK, NY, 10038, US

(21) Appl. No.: 11/365,631

(22) Filed: Feb. 28, 2006

(51) Int. Cl. G06K 9/00

(52) U.S. Cl. 382/166

(57) ABSTRACT

Described is a system and method for decoding a color image. The method comprises capturing a color image, obtaining a luminance component from the color image and decoding the luminance component.

### FIELD OF THE INVENTION

The present invention relates generally to systems and method for decoding a color image.

### BACKGROUND

Some conventional imaging engines use a decoding algorithm which requires, as input, a gray scale image. The decoding algorithm identifies indicia (e.g., a bar code, an image, a signature, etc.) in the image, and decodes and/or stores the indicia. Generally, the imaging engine is an integral part of an electronic device which also includes a display for previewing an image of the indicia and data as a result of decoding the indicia. The preview of the image may facilitate aiming the imaging engine. When the electronic device utilizes a color image capture device for producing a color image, rather than the gray-scale image, the color image must be converted to a corresponding gray-scale image, because the conventional imaging engines utilize a gray scale decoding algorithm. The conversion from color to gray scale is computationally intense and time-consuming, requiring extensive copying and manipulation of the color image to produce the gray-scale image.

### SUMMARY OF THE INVENTION

The present invention relates to a system and method for decoding a color image. The method comprises capturing a color image, obtaining a luminance component from the color image and decoding the luminance component.

An arrangement according to the present invention comprises an image capture device capturing a color image which comprises at least a luminance component. The arrangement further includes a memory storing the luminance component, and a decoder decoding the luminance component.

### DESCRIPTION OF THE DRAWINGS

FIG. 1 shows an exemplary embodiment of a scanning arrangement for decoding a color image.

FIG. 2 shows an exemplary embodiment of a method for decoding a color image.

### DETAILED DESCRIPTION

The present invention may be further understood with reference to the following description and the appended drawings, wherein like elements are referred to with the same reference numerals. The present invention describes a system and method for decoding a color image. While the exemplary embodiments are described with reference to an image capture device and an imager-based scanner, those of skill in the art will understand that the present invention may be implemented on any electronic device which generates and decodes color images. In the exemplary embodiments, the image capture device may include a sensor, imager, color camera or other device, and a hardware interface for producing an image in a predefined format (e.g., YCbCr format).

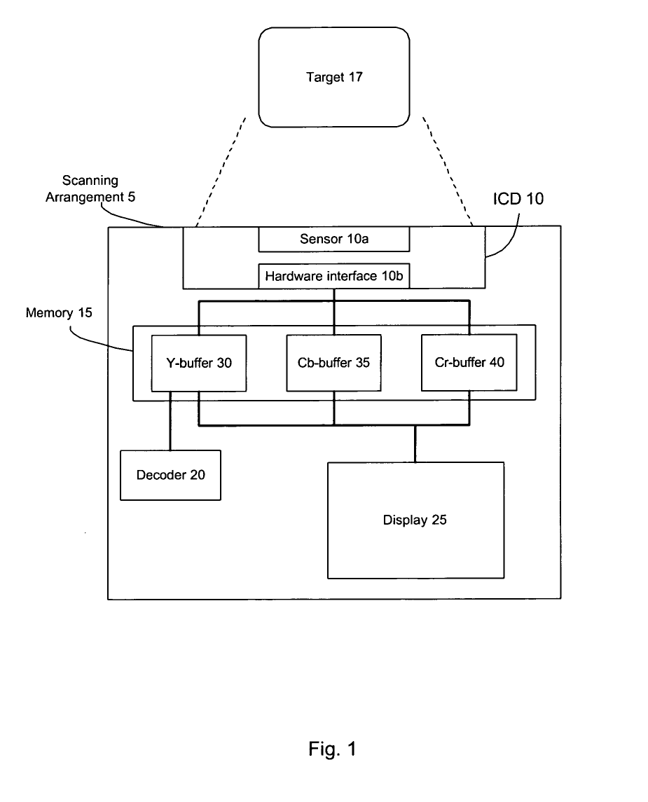

FIG. 1 shows an exemplary embodiment of a scanning arrangement 5 for decoding a color image according to the present invention. The scanning arrangement 5 may be included in an imager-based scanner or any mobile computing device including, but not limited to, a mobile phone, a PDA, a handheld computer, a laptop, etc. In an alternative embodiment, the scanning arrangement 5 may be wired or wirelessly coupled to stationary computing device such as, for example, a PC, a Point-of-Service device, a server, etc.

In the exemplary embodiment, the scanning arrangement 5 includes an image capture device 10, a memory 15, a decoder 20 and a display 25. The image capture device 10 may comprise, for example, a sensor 10a and a hardware interface 10b. The sensor 10a maybe an imager, a color camera or another device capable of producing an image in a predefined format (e.g., a YCrCb format), as will be explained further below. As will be further described below, the image capture device 10 generates image data which is routed to the memory 15 by the hardware interface 10b and decoded by the decoder 20. The display 25, e.g., an LCD overlay, may generate a preview of the scan data allowing a user of the scanning arrangement 5 to visually confirm that a target 17 was scanned. While the exemplary embodiment of the scanning arrangement 5 is described as including the decoder 20 and the display 25, those of skill in the art will understand that the decoder 20 and/or logic utilized thereby (e.g., decoding algorithms) may be included in a processing unit coupled to the scanning arrangement 5 via a wired and/or wireless coupling, or through any intermediate circuit or device. Thus, the decoder 20 may also have an output to a further device or processing module that will operate on the decoded image acquired by the scanning arrangement 5. In addition, the display 25 may be a component of the mobile computing device including the scanning arrangement 5 or a stand-alone display unit coupled to the scanning arrangement 5 and/or mobile computing device.

The scanning arrangement 5 utilizes the image capture device 10 to generate the image data which, in the exemplary embodiment, is a color image of the target 17 (e.g., bar code, image, signature, photograph, etc.). The color image generated by the image capture device 10 may be determined by a mode of operation of the image capture device 10. For example, when the image capture device 10 is initialized into a predetermined format, e.g., one of the YCbCr formats (e.g., YCbCr 4:2:2), and the hardware interface 10b is configured to format the image data into a planar format, the image capture device 10 generates image data (e.g., YCbCr 4:2:2) which the hardware interface 10b separates into three components in a YCbCr format. The components are also utilized to reconstruct the color image, as will be explained further below. A first component, a Y-component data, corresponding to luminance data, represents an intensity component of the color image. Second and third components, Cb and Cr component data, correspond to chrominance data and represent blue chrominance (Cb) and red chrominance (Cr) components, respectively. When the image capture device 10 is in a packed mode, all of the component data, Y, Cb and Cr, are mixed/interleaved together, resulting in small “packs” of the component data in a single, big color image. In an alternative exemplary embodiment, the image capture device 10 may only generate the Y-component. Those of skill in the art will understand that any video- and/or still-image format capable of producing a gray scale intensity value similar in function to luminance may be utilized with the present invention.

According to the exemplary embodiments of the present invention, the image capture device 10 captures the color image of the target 17 and the hardware interface 10b is configured to format the color image into a planar format. The hardware interface 10b deconstructs the color image into the three components (or at least the Y-component data) and routes each of the components to a corresponding buffer in the memory 15. Then, simultaneously, the Y-component data, is sent from a Y-buffer 30 to the decoder 20 and the display 25, and the Cb- and Cr-component data are sent from a Cb-buffer 35 and a Cr-buffer 40, respectively, to the display 25. Thus, the decoder 20 may execute a decoding algorithm (e.g., a gray scale decoding algorithm) on the first image, while the color image is reconstructed on the display 25 using the Y, Cb- and Cr-component data. In an alternative exemplary embodiment, the decoding algorithm may be executed on the Y-component data while it is in the Y-buffer 30. The color image on the display 25 provides a video preview of the color image prior to its decoding, allowing a user to visually confirm capture of the target 17.

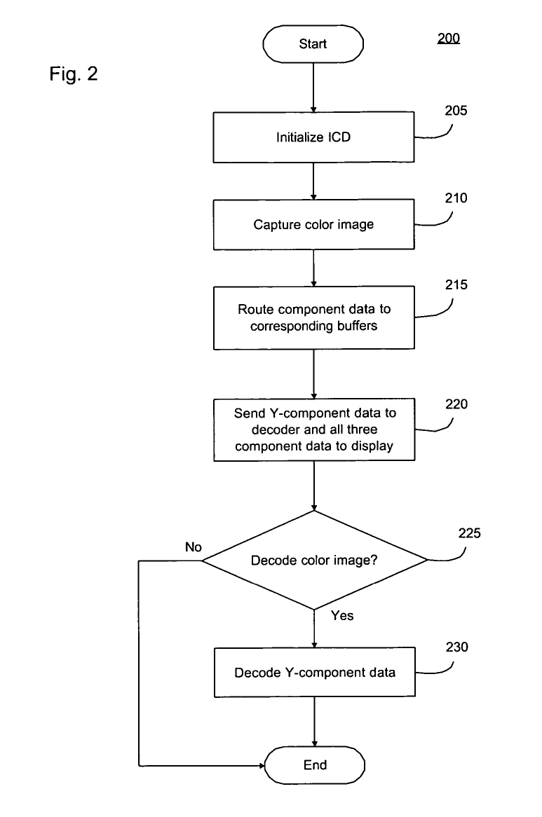

FIG. 2 shows an exemplary embodiment of a method 200 for decoding a color image according to the present invention. In step 205, the image capture device 10 is initialized in the YCbCr format (e.g., YCbCr 4:2:2). The initialization may occur at, for example, power-up, waking from a sleep mode and/or upon receipt of a manually-entered instruction by the user of the scanning arrangement 5.

In step 210, the image capture device 10 captures the color image of the target 17 using the sensor 10a. As described above, when the hardware interface 10b is configured to format the color image in the planar format, the hardware interface 10b separates the color image into the Y-, Cb- and Cr-component data. Alternatively, only the Y-component data may be extracted. This may occur when, for example, the display 25 is a gray scale display.

In step 215, the Y-, Cb- and Cr-component data are routed to the corresponding buffers in the memory 15 by the hardware interface 10b. That is, the Y-component data is routed to the Y-buffer 30, the Cb-component data is routed to the Cb-buffer 35 and the Cr-component data is routed to the Cr-buffer 40. Forwarding each of the components to the corresponding buffer may be accomplished using, for example, a direct memory access (DMA) channel to each buffer. For example, the hardware interface 10b may transmit the Y-component data directly from the image capture device 10 to the Y-buffer 30 in the memory 15 over a first DMA channel.

In step 220, the Y-component data is input to the decoder 20, and all three component data are forwarded to the display 25 for reconstructing the color image of the target 17 thereon. Thus, the color image of the target may be previewed, allowing the user to visually confirm that the target 17, or relevant portion thereof, is included in the color image captured by the image capture device 10. Those of skill in the art will understand that the Y-component data may be forwarded to the display 25 while a copy is retained in the Y-buffer 30, or vice-versa. In the alternative, the decoder 20 may execute the decoding algorithm in-place on the Y-buffer 30.

In step 225, it is determined whether the color image should be decoded. In the exemplary embodiment, the scanning arrangement 5 may wait until an instruction is received before decoding the color image. For example, the user may utilize the display 25 to visually confirm that the target 17 has been captured. The user may provide an instruction (e.g., press a key on a keypad, squeeze a trigger, etc.) to the scanning arrangement 5 to initiate decoding of the color image. That is, the user may press a first key to capture the color image, and press a second key (or the first key again) to instruct the scanning arrangement 5 to decode the color image. In another exemplary embodiment, the scanning arrangement 5 may attempt to decode every image which is captured by the image capture device 10. This may be useful during swipe scanning.

In step 230, the scanning arrangement 5 has received the instruction to decode the color image. According to the present invention, the Y-component data of the color image in the Y-buffer 30 is decoded. In the exemplary embodiment, the decoding algorithm may work in-place on the Y-buffer 30. In an alternative embodiment, the Y-component data may be forwarded to the decoder 20 (integral with or coupled to the scanning arrangement 5) for decoding.

As explained above, the scanning arrangement 5 may utilize a gray scale decoding algorithm. The Y-component data of the color image is the input to the decoding algorithm. Thus, the color image is not required to be processed, i.e., converted to a gray scale image, prior to decoding. Bypassing the conversion to the gray scale image may reduce decoding times and memory used by the scanning arrangement 5.

In another exemplary embodiment, the color image may be captured in the planar format, and the Y-component data is copied into a contiguous buffer containing only the Y-component data of the color image. The decoding algorithm is then executed using the Y-component data in the contiguous buffer as input. This embodiment, similar to the one described above, may use extra memory and/or introduce a delay in the decoding process.

The present invention allows products equipped with a color capture device to implement full color preview on the display while still allowing use of gray scale decoding algorithms without any (or very little) performance penalty for converting the color image into a gray scale image. That is, because a display controller coupled to the display 25 converts the color image into a red-green-blue (RGB) colorspace, the display 25 may be used to show a video preview of the color image prior to decoding. The video preview may be beneficial for ensuring that the image capture device 10 is properly aimed at the target 17.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
capturing a color image;
obtaining a luminance component from the color image; and
decoding the luminance component.

2. The method according to claim 1, further comprising:
initializing an image capture device in a YCbCr format.

3. The method according to claim 2, further comprising:
obtaining a chrominance component from the color image.

4. The method according to claim 3, wherein the luminance component is Y-component data.

5. The method according to claim 3, wherein the chrominance component includes Cb-component data and Cr-component data.

6. The method according to claim 3, further comprising:
transferring the luminance and chrominance components to respective buffers.

7. The method according to claim 6, wherein the transferring step is performed using a respective direct memory access channel for each of the respective buffers.

8. The method according to claim 3, further comprising:
reconstructing the color image on a display as a function of the luminance and chrominance components.

9. The method according to claim 1, wherein the decoding step is performed using a gray scale decoding algorithm.

10. The method according to claim 1, wherein the color image includes an image of at least one of a bar code, a fingerprint, a signature, a photograph and a picture.

11. An arrangement, comprising:
an image capture device capturing a color image, the color image comprising at least a luminance component;
a memory storing the luminance component; and
a decoder decoding the luminance component.

12. The arrangement according to claim 11, wherein the image capture device is one of a color sensor, a color camera and a color imager.

13. The arrangement according to claim 11, wherein the image capture device captures the color image in a YCbCr format.

14. The arrangement according to claim 13, wherein the color image further includes a chrominance component.

15. The arrangement according to claim 14 wherein the luminance component is Y-component data.

16. The arrangement according to claim 15 wherein the chrominance component includes Cb-component data and a Cr-component data.

17. The arrangement according to claim 16 wherein the memory includes buffers storing each of the Y-, Cb- and Cr-component data.

18. The arrangement according to claim 17 wherein the Y-, Cb- and Cr-component data are transferred from the image capture device to the buffers via respective direct memory access channels.

19. The arrangement according to claim 14, further comprising:
a display reconstructing the color image as a function of the luminance and chrominance components.

20. The arrangement according to claim 11, wherein the arrangement is one of an imager-based scanner, a mobile phone, a PDA and a laptop.

21. The arrangement according to claim 11, wherein the color image includes an image of at least one of a bar code, a fingerprint, a signature, a photograph and a picture.

22. A device, comprising:
an image capture device capturing a color image;
a hardware interface extracting gray scale intensity data from the color image; and
a decoder decoding the gray scale intensity data.

23. An arrangement, comprising:
an image capture means for capturing a color image, the color image comprising luminance and chrominance components;
a storage means for storing the luminance component; and
a decoding means for decoding the luminance component.
